(19) United States
(12) Patent Application Publication
(10) Pub. No.: US 2014/0003233 A1
(43) Pub. Date: Jan. 2, 2014

(54) Gateway Allocation in a Mobile Communication System

(71) Applicants: Johan Rune, Lidingo (SE); Åke Arvidsson, Solna (SE); Attila Mihály, Dunakeszi (HU)

(72) Inventors: Johan Rune, Lidingo (SE); Åke Arvidsson, Solna (SE); Attila Mihály, Dunakeszi (HU)

(73) Assignee: TELEFONAKTIEBOLAGET L M ERICSSON (PUBL), Stockholm (SE)

(21) Appl. No.: 13/979,735

(22) PCT Filed: Jan. 20, 2011
(86) PCT No.: PCT/EP2011/050772

§ 371 Date: Sep. 19, 2013

(51) Int. Cl. H04W 28/08

(52) U.S. Cl. CPC H04W 28/085
USPC 370/230

(57) ABSTRACT

The present invention relates to a mobility management control node (111, 113) of a mobile communications network (100) and to a method in the mobility management control node (111, 113). According to the method a 5 gateway (105, 106, 117) is allocated to a bearer (110, 118). The method comprises determining an appropriate gateway for the bearer (110, 118) and obtaining load information indicating a current load of the determined appropriate gateway. If the load information indicates that the current load of the determined appropriate gateway is above a predetermined threshold 10 value of the determined appropriate gateway, a gateway out of the determined appropriate gateway and at least one other gateway is selected based on information associated with the bearer. On the other hand, if the load information indicates that the current load of the determined appropriate gateway is below or at the predetermined threshold value, the determined 15 appropriate gateway is selected. The selected gateway is allocated to the bearer (110, 118).

### TECHNICAL FIELD

The present invention relates to the gateway allocation in a mobile communication system and in particular to a method and a mobility management control node for gateway allocation to a number of traffic bearers.

### BACKGROUND

In mobile communication systems gateways need to be selected and allocated from time to time. Examples of mobile communications systems in which gateway allocation may be required are 3^{rd} Generation/Universal Mobile Telecommunications System (3G/UMTS) and 3^{rd} Generation Partnership Project (3GPP) Evolved Packet System (EPS). In 3G/UMTS, a Gateway GPRS Support Node (GGSN) may e.g. be allocated for a connection of a user equipment (UE) via a Universal Terrestrial Radio Access Network (UTRAN). In EPS, e.g. in connection with a Packet Data Network (PDN) connection establishment, a Serving Gateway (SGW) or a PDN Gateway (PGW) may be selected.

Using EPS as an example, some aspects relating to gateway allocation will now be discussed in more detail to provide a better understanding of the solutions presented herein.

According to the EPS network architecture, a bearer for a PDN connection may span a number of user plane nodes from a UE, via an eNodeB (eNB), a Security Gateway (SeGW) at a border of an operator network, the SGW to the PGW. In many cases the path of the traffic over the PDN connection continues from the PGW to an Autonomous System Border Router (ASBR), i.e. one of the operator's border routers constituting a peering point with other carriers, and further into the Internet. A Mobility Management Entity (MME) is a pure control plane node which, among other tasks, is involved in PDN connection establishments.

When a PDN connection is established, or its path is altered, some or all of the traversed nodes need to be selected or reselected. Different selection mechanisms are used for different nodes:
The eNB is generally selected by the UE, governed by radio conditions and guiding parameters in system information broadcasted in the cells. In case of inter-eNB handover, a source eNB selects a target eNB based on measurement data from the UE.
The SeGW selection is simply a consequence of the eNB selection, since the SeGW that the eNB is connected to should be used.
The SGW is selected by the MME. The SGW is selected for a default bearer at network Attach, i.e. when the UE attaches to the network. The UE can only have a single SGW allocated at a time, so the same SGW is used also for subsequent bearers, irrespective of Access Point Name (APN). The allocated SGW can be changed due to mobility, e.g. at handover or Tracking Area Update (TAU), in order to optimize the route or because the old SGW does not serve the new eNB. A SGW may serve a limited part of the Public Land Mobile Network (PLMN) area, i.e. a limited fraction of the eNBs in the PLMN, denoted SGW Service Area (SA). SGW relocation due to fault situations is also possible.
The PGW is selected by the MME. The PGW is selected for the default bearer for a certain APN. A UE can only have a single PGW allocated at a time for a certain APN, so the same PGW is used also for subsequent bearers for the same APN. A PGW is allocated to the UE for each APN the UE chooses to use for communication, i.e. to establish a bearer for. Hence, a UE can be allocated multiple PGWs, one for each APN. An allocated PGW is not changed—it remains the same irrespective of mobility for as long as the UE remains attached to the network (for each APN). Hence, each PGW should serve the entire PLMN.
The ASBR is selected through routing information and policies in the transport network layer and may hence in essence be seen as a consequence of the PGW selection.

SGW/PGW selection takes place in the network whenever a SGW and/or a PGW needs to be allocated to a UE, either to serve a new PDN connection, i.e. a new APN, or to replace a previously allocated SGW. There are three cases in which SGW/PGW selection is triggered:
Attach (which includes establishment of an initial PDN connection and default bearer). In this selection case both SGW and PGW are selected.
SGW relocation. In this selection case only the SGW is selected, while the PGW(s) remain(s) fixed.
Additional PDN connection establishment for an additional APN. In this selection case only a PGW is selected, while the already allocated SGW is reused.

In general there are various conceivable selection criteria that an MME may consider when selecting SGW and PGW. Some criteria must be fulfilled by the selected node. For instance, a selected PGW must support the APN that is associated with the concerned PDN connection and a selected SGW must serve the area (i.e. cell/eNB) where the UE is located. Other criteria may or may not be fulfilled or may be fulfilled to a varying degree. Examples of such criteria that are applicable to both SGW and PGW selection include path optimization (e.g. topological closeness) and load balancing/distribution.

According to present applicable 3GPP specifications TS 29.303 v8.3.0 and TS 23.003 v9.0.0 the mechanisms that the MME can leverage to enable appropriate selections of SGWs/PGWs are based on a Straightforward Name Authority Pointer (S-NAPTR) DNS application. S-NAPTR uses resource records (RRs) of types NAPTR and SRV for storing information that may be used for selection of an appropriate SGW or PGW. Examples of types of information that may be stored in NAPTR resource records and which may be of interest for SGW or PGW selection are Tracking Area ID (TAI), supported mobility protocol, supported APN and information indicative of topological closeness. In order to let several different types of information impact the SGW/PGW selection, multiple NAPTR RRs may have to be retrieved, corresponding to multiple Domain Name System (DNS) queries. However, the DNS mechanisms contain optimizations that drastically reduce the number of DNS queries required in practice. DNS servers send “additional section” information in their replies, which attempt to foresee and preclude subsequent requests, and in addition, DNS clients may cache received DNS replies, which may eliminate a majority of the queries.

Nevertheless, even though most of the DNS queries may be avoided, a series of Fully Qualified Domain Names (FQDNs), corresponding to potential queries, are involved in the procedure from the FQDN in the initial query to the FQDN in the finally returned resource record. The structure of the initial input FQDN and final output FQDN are specified by 3GPP, but the arbitrary number of intermediate FQDNs are left entirely to each operator to use in any way they assess beneficial, e.g. to encode other SGW/PGW properties which may be useful in the SGW/PGW selection process.

Load management is a general term which includes different aspects, such as load balancing, load control and overload protection. Load balancing is the process of maintaining reasonably equivalent loads among several entities performing similar tasks, in order to achieve good performance and efficient resource utilization. Load control is the process of controlling the load of a system, so that the system can maintain acceptable performance. Overload protection involves protecting a system from loads that may threaten its stability.

In terms of load management the 3GPP standard enables a weighted distribution of UE allocations to SGWs and PGWs, based on “preference” parameters in DNS NAPTR resource records and “weight” parameters in DNS SRV resource records. That is, the MME may distribute its allocations of UEs to SGWs and PGWs based on semi-statically configured DNS parameters.

In addition, SGWs and PGWs may more or less explicitly indicate overload conditions to the MME when the MME requests resources from the GWs. These indications are thus not spontaneous (i.e. initiated unsolicited by the GWs), but are included in General Packet Radio Service Tunneling Protocol version 2 Control plane (GTPv2-C) messages returned when (partially or entirely) rejecting request messages from the MME. The overload indications comes in the form of cause values, i.e. values of the Cause information element (IE), in the Create Session Response message (cause values “No memory available” and “No resources available”), the Modify Bearer Failure Indication message (cause values “No memory available” and “No resources available”), the Create Indirect Forwarding Tunnel Response message (cause value “No resources available”), the Modify Bearer Response message (cause values “No memory available” and possibly “Request rejected” and “Request partially accepted”).

In a wider context management of gateway loads is closely related to gateway selection in the sense that the load management aspect is one of the criteria that the MME may consider when selecting a gateway for a UE (other possible criteria include e.g. path optimization and supported features). However, accounting for load management in the gateway selection process may impact other gateway selection criteria. For instance, an MME may for load management reasons choose a gateway for which the path is less optimal than for another gateway, hence resulting in increased transport network transmission costs. On the other hand, if the path optimization aspect takes precedence over the load management aspect, the consequences may be that the load of a gateway becomes unfavorably high and that users allocated to this gateway experience degraded service quality, e.g. in the form of lower bit rates and increased delays for best effort services.

### SUMMARY

An object of the present invention is to provide a method and arrangement that provide for improved possibilities for an appropriate gateway allocation in a mobile communication system.

The above stated object is achieved by means of a method and a mobility management control node according to the independent claims.

A first embodiment provides a method in a mobility management control node of a mobile communications system for allocating a gateway to a bearer of traffic. The method comprises a step where an appropriate gateway for the at least one bearer is determined. In a further step of the method load information indicating a current load of the determined appropriate gateway is obtained. If the load information indicates that the current load of the determined appropriate gateway is above a predetermined threshold value of the determined appropriate gateway, a gateway out of the determined appropriate gateway and at least one other gateway is selected, based on information associated with the at least one bearer. On the other hand, if the load information indicates that the current load of the determined appropriate gateway is below or at the predetermined threshold value, the determined appropriate gateway is selected. The selected gateway is allocated to the bearer in another step of the method.

A second embodiment provides a mobility management control node for use in a mobile communications system. The mobility management control node comprises processing circuits configured to allocate a gateway to a bearer of traffic. The processing circuits are configured to determine an appropriate gateway for the bearer. The processing circuits are further configured to obtain load information indicating a current load of the determined appropriate gateway. If the load information indicates that the current load of the determined appropriate gateway is above a predetermined threshold value of the determined appropriate gateway, the processing circuits are configured to select a gateway out of the determined appropriate gateway and at least one other gateway based on information associated with the bearer. On the other hand, if the load information indicates that the current load of the determined appropriate gateway is below or at the predetermined threshold value, the processing circuits are configured to select the determined appropriate gateway. The processing circuits are also configured to allocate the selected gateway to the bearer.

Advantages and features of embodiments of the present invention will become apparent when reading the following detailed description in conjunction with the drawings.

### BRIEF DESCRIPTION OF THE DRAWINGS

FIG. 1 is a schematic block diagram illustrating a mobile communication system in which embodiments of the present invention may be implemented.

FIG. 2 is a flow diagram illustrating an embodiment of a method in a mobility management control node for gateway allocation.

FIG. 3 is a flow diagram of an alternative embodiment of a method in a mobility management control node for gateway allocation in which explicit load information from gateways is used as input.

FIG. 4 is a flow diagram of another alternative embodiment of a method in a mobility management control node for gateway allocation in which an estimated gateway load is used as input.

FIG. 5 is a schematic block diagram illustrating an embodiment of a mobility management control node.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements.

Embodiments described herein provide possibilities to allocate an appropriate gateway and to selectively off-load a gateway (GW) that is highly loaded. Through a selective off-loading strategy the negative impacts of load management on other aspects may be minimized or even turned into advantages.

According to embodiments described in further detail below, a mobility management control node, such as a MME or SGSN, obtains gateway load information either directly from one or several gateways or through estimations in the mobility management control node. Based on the obtained load information the mobility management control node determines when a GW has a current load over a predetermined threshold value that indicates that the GW is close to being overloaded. When the GW is close to being overloaded it may be beneficial to apply selective off-loading strategies for the GW and to choose carefully how to best utilize the last remaining capacity in the highly loaded GW. It may be appropriate to allocate the highly loaded GW to some bearers, while it is better to allocate another GW to other bearers, even if the other GW is less optimal e.g. from a path optimization perspective. The most appropriate gateway depends on different properties associated directly or indirectly with the bearer(s) that is/are to be allocated a gateway, such as expected traffic volume to be carried by the bearer or a priority of the user associated with the bearer. The most appropriate gateway may also depend on different capacity limits of the gateway and in which way the gateway is close to being overloaded.

In the context of load management involving GWs, such as SGWs and PGWs, it is important to be aware of some properties of these nodes in terms of load and capacity limits. The GWs may be limited by licensed capacity, giving e.g. the maximum number of simultaneous bearers per node, or by hardware capacity, which is generally given by possible bottlenecks of the node's hardware, such as processing power and/or the number of interface/line cards that are installed per node and the maximum capacity of one interface/line card.

A license limit may be set purely by agreement, while the true capacity of the equipment hardware may be much larger, or it may be that the two limits are rather close to each other. The former option may be motivated by the fact that it may be economical to always fully equip all nodes leaving the factory e.g. due to simplicity, economy of scale, or the fact that it is not required to manually install new boards when the license agreement is upgraded to a greater capacity. The latter option, on the other hand, may be motivated by the fact that it would be wasteful to equip a node with more boards than it needs in order to fulfill its licensed capacity and, if the boards are used for gradual capacity increase, the difference between the licensed limit and the hardware capacity limit will not be great.

The properties/behavior of a GW as its load increases towards the limit may be quite different in license limited GWs and hardware limited GWs. For instance, a license limit may block further bearer allocations when the GW is far from overloaded, which means that the GW will maintain more or less undegraded performance, but will start rejecting requests when the license limit is reached. On the other hand, if the hardware is the actual limiting factor, then the GW's ability to properly serve connected user equipments (UEs) may be adversely affected even before (possibly even far before) the GW is actually deemed as overloaded. Because of these consequences of the different types of capacity limits, a license limit may be referred to as a hard capacity limit i.e. a sharp “non-negotiable” cut-off of service above a certain load, and a hardware limit may be referred to as a soft capacity limit, which implies a gradual degradation of service with increasing load. Correspondingly, a GW with a license limit may be referred to as a hard limited GW, while a hardware limited GW may be referred to as a soft limited GW.

In this description the terms “soft limitation threshold” and “hard limitation threshold” will be used to refer to different types of predetermined thresholds related to the current load of a GW. A soft limitation threshold is a threshold value relative to a soft capacity limit of the GW, i.e. to a capacity limit that is related to the traffic volume handled by the GW or in other words a traffic volume capacity limit. A hard limitation threshold is a threshold value relative to a hard capacity limit of the GW, i.e. to a capacity limit on the number of simultaneous bearers, the number of users or the number of user equipments handled by the GW.

The appropriate GW allocation strategy may be different for soft and hard limited GWs. For instance, in case of a soft limited GW the operator may opt to let the MME direct prioritized users, e.g. gold subscribers, to other GWs, in order to spare them the inconvenience, in the form of service degradation and/or bearer rejection, of being connected to a highly loaded GW. On the other hand, in the case of a hard limited GW (e.g. limited in the number of supported bearers through a license agreement), the MME may instead minimize the increased transmission costs by directing low volume users to less transmission optimal GWs, while high volume users remain in the highly loaded GW.

To facilitate the further description of the different embodiments the following notation is introduced:

GW X A GW which is transmission optimal i.e. the best GW from a user plane path optimization perspective, or deemed appropriate from the perspective of other criteria disregarding GW load, but with a load that is approaching the GW's capacity limit.
GW Y A GW which is worse than GW X from a transmission user plane path optimization perspective, or other criteria disregarding GW load, but which is less loaded than GW X.

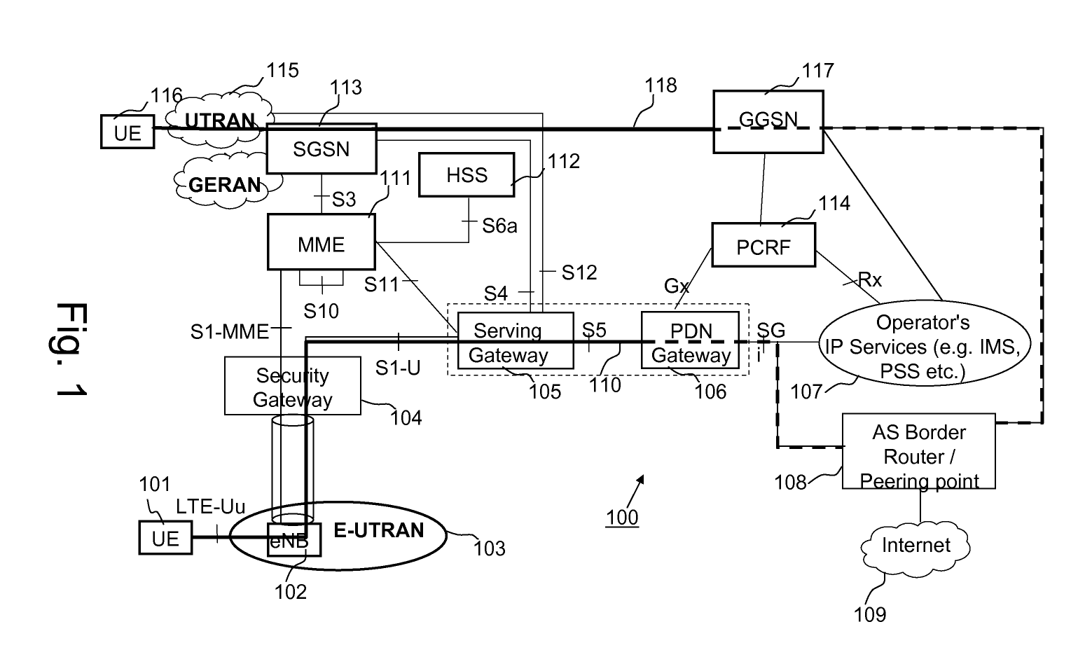

FIG. 1 is a schematic block diagram illustrating a mobile communication system 100 in which embodiments of the present invention may be implemented. FIG. 1 provides an illustration of the EPS network architecture according to which a bearer 110 for a PDN connection may span a number of user plane nodes from a UE 101, via an eNodeB (eNB) 102 in a Evolved Universal Terrestrial Radio Access Network (E-UTRAN) 103, a Security Gateway (SeGW) 104 at a border of an operator network, a SGW 105 to a PGW 106. Through the PGW, access may be given to the operator's Internet Protocol (IP) services 107, such as IP Multimedia Subsystem (IMS) and Packet-switched Streaming Service (PSS). In many cases the path of the traffic over the PDN connection continues from the PGW 106 to an Autonomous System Border Router (ASBR) 108, i.e. one of the operator's border routers constituting a peering point with other carriers, and further into the Internet 109. A Mobility Management Entity (MME) 111 is a mobility management control node which, among other tasks, is involved in PDN connection establishments. The MME 111 is responsible for authenticating users by interacting with a Home Subscriber Server (HSS) 112. The MME 111 also provides a control plane function for mobility between E-UTRAN 103 and 2G/3G access networks 115 with an S3 interface terminating at the MME 111 from an SGSN 113. A Policy and Charging Rules Function (PCRF) 114 is provided to determine policy rules and access subscriber databases and other specialized functions such as charging systems. In 3G/UMTS networks, the SGSN 113 has a similar role as the MME 111 as a mobility management control node. However the SGSN 113 is also a user plane node with comparable function as the SGW 105, i.e. the SGSN 113 is a combined mobility control node and user plane node. Accordingly a bearer 118 for a connection from a UE 116 in a UTRAN 115 to the Internet 109 may be established under the control of the SGSN 113 and via the SGSN 113, a GGSN 117 and the ASBR 108. The GGSN 117 has a corresponding role as the PGW 106.

GW allocation is performed for both the bearer 110 and the bearer 118. For the bearer 110, it is the MME 111 that allocates the SGW 105 and PGW 106. For the bearer 118, it is the SGSN 113 that allocates the GGSN 117.

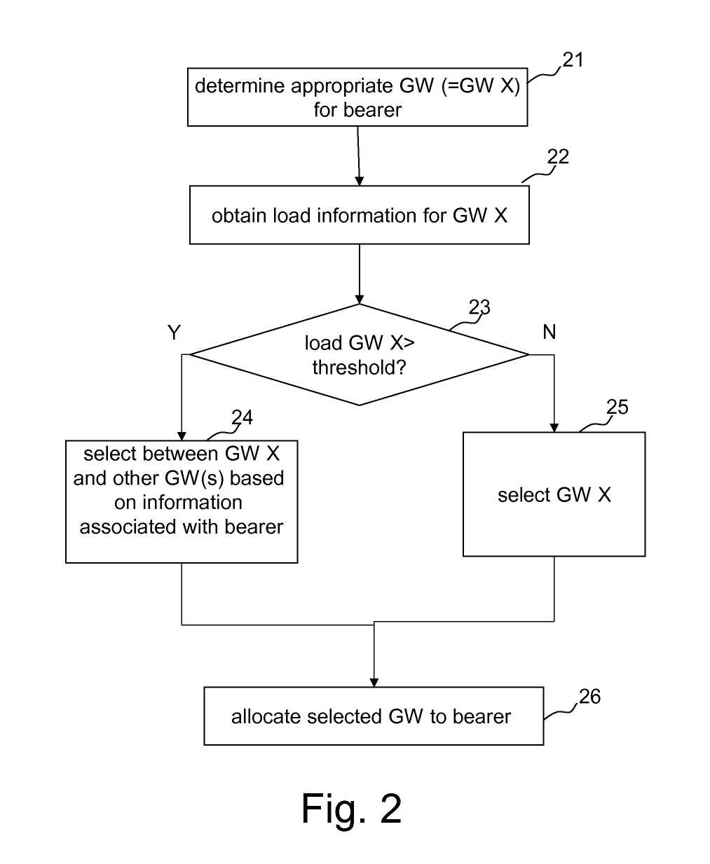

FIG. 2 is a flow diagram illustrating an embodiment of a method in a mobility management control node, such as the MME 11 or the SGSN 113, for gateway allocation. In a step 21 an appropriate GW for at least one bearer is determined, e.g. by means of determining the transmission optimal GW (e.g. GW X) according to a conventional method. The determined appropriate GW does not have to be the optimal GW from a path optimization perspective, but should fulfill absolute requirements to be able to function as a GW for the at least one bearer, such as supporting the APN that is associated with the PDN connection of the bearer 110 in case of PGW allocation, or serving the area where the UE 101 is located in case of SGW allocation. Thus the determined appropriate GW is a possible candidate for allocation to the at least one bearer. Generally, the determined appropriate gateway is the GW that is believed to be the best candidate from a transmission perspective or according to another perspective that does depend on the load of the GW. In this example it is assumed that GW X is determined in the step 21.

In a step 22, load information indicating a current load of the determined appropriate gateway is obtained. This load information may be obtained in many different ways as will be explained in further detail. The load information may e.g. be explicit load information that is retrieved from several different gateways or it may be an estimate based on previous gateway allocations performed by the mobility management control node. It should be noted that the steps 21 and 22 may be performed in the reverse order and that the step 22 may include obtaining load information for several different GWs, i.e. not only for the determined appropriate gateway (in this example GW X).

In a step 23, it is determined if the load information obtained in the step 22 indicates that the current load of the determined appropriate GW (here GW X) is above a predetermined threshold value. The predetermined threshold value is chosen to indicate a load level when the GW is approaching a capacity limit such that it is of interest to carefully consider how the remaining capacity is used. As mentioned above there may be different types of capacity limits associated with the GW. Accordingly there may also be different predetermined threshold values relative to the different types of capacity limits. In particular the predetermined threshold value may be a soft limitation threshold or a hard limitation threshold.

If the current load of the GW is indicated to be above the predetermined threshold value considered in the step 23, a selective GW allocation strategy is applied in a step 24 in which a selection is made between the determined appropriate GW (here GW X) and one or several other GWs, such as GW Y based on information associated with the bearer(s) for which GW allocation is to be performed. In the step 24, information such as priority of the user, expected traffic volume to be carried by the bearer(s) and UE type may be considered. Different types of information that may be considered for the GW selection in the step 24 will be discussed in further detail below. Step 24 may result in selection of the determined appropriate GW (here GW X) or another GW. The step 24 is a selection procedure in which additional information that normally would not be considered in the step 21 is used to select between the transmission optimal GW X and one or several other possible GWs. However, if the current load of the GW is indicated to be below (or at) the predetermined threshold value, the GW that was determined in the step 21 is selected in a step 25, without considering using any other GWs and without considering any additional information associated with the bearer(s). The selected GW is then allocated to the bearer(s) in a step 26.

When there is only a little capacity left in a GW (e.g. GW X), the mobility management control node, such as the MME 111, may do more than distribute load and avoid overload. The MME 111 may also consider how to best utilize the remaining capacity. In addition, if the users experience degraded service quality in a loaded GW (e.g. GW X), the MME may consider which users should primarily be spared this inconvenience. With these aspects in mind the MME may use any available information that distinguishes users to choose which users to allocate to other GWs (e.g. GW Y) and which to be handled by the loaded GW's (e.g. GW X's) remaining capacity. The MME 111 may thus choose to allocate users to other GWs, which may be suboptimal e.g., from a topology/path perspective (e.g. GW Y), even when there is capacity left in the first-choice GW (e.g. GW X), in order to reserve the last capacity for other potential users or to ensure that the redirected users do not suffer undue service degradation, should the load in the first-choice GW (e.g. GW X) increase. The MME 111 may also use the selective off-loading strategy according to the step 24 to balance the load in relation to license and hardware capacity limits respectively. The GW may well have both types of capacity limits and the control plane (CP) and user plane (UP) loads may be balanced depending on the GW implementation. Without such balancing one of the capacity limits may be reached while there is still a wide margin to the other capacity limit, which would mean that GW resources are wasted. On the other hand, assuming for example that the CP capacity is primarily license limited while the UP capacity is hardware limited, using selective off-loading of high or low volume users the MME/operator may control the CP and UP loads such that both the CP and UP capacities of a GW are fully, or at least comparatively efficiently, utilized.

Potential advantages of such selective off-loading may be seen from both the operator's and the users' perspectives and the choice of which to target determines the operator's selective off-loading strategy.

From the operator's perspective the following advantages may be obtained/desirable:
If the user plane paths differ significantly for different GWs (e.g. between GW X and GW Y), the traffic that has to traverse the longer path(s), and thus the increased transmission costs, may be minimized.
Ability to differentiate services.
Ability to balance GW loads relative to license limits and hardware limits in order to more efficiently utilize the GW resources.

From the user's perspective the following advantages may be obtained/desirable:
Prioritized users may avoid undesirable service degradation. Non-prioritized users may experience less service degradation than they would otherwise.
Prioritized users may avoid rejection of connection establishment. For non-prioritized users the risk for rejection of connection establishment may be reduced.

The operator and user perspectives will sometimes favor contradicting actions, so a trade-off between user satisfaction and operator satisfaction may be needed.

Furthermore, the situation differs between hard and soft limited GW, such as license limited GWs and hardware limited GWs. In the license limited case the objective from the operator perspective would be to minimize the increased traffic volume/cost in the transport network resulting from allocating users to a GW with a longer or otherwise less favorable user plane path (e.g. GW Y). The users who are still allocated to the loaded GW (e.g. GW X) will normally not experience any service degradation since the capacity limit is hard. However, if a user is allocated to the loaded GW (e.g. GW X) and then wants to establish another bearer, there is a risk that this bearer cannot be accommodated within the license limit, which constitutes a potential disadvantage for the user. In the hardware limited case both the operator and the users are affected by the choices, since the user plane path, and thus transport network load/cost, is affected for the redirected users, while the service is degraded for the non-redirected best effort users. Since the level of service may start to decrease noticeably far before a hardware limited GW is actually declared overloaded (especially so if the processing capacity is the scarcest resource), there may be good reasons to start decreasing the allocations to a hardware limited GW, using selective off-loading, quite early.

Hence, in the license limited case the operator would benefit from directing low volume users to other GWs (e.g. GW Y) while keeping the high volume users in the highly loaded GW (e.g. GW X), provided that the license limit, as assumed, is defined as a maximum number of bearers, i.e. not directly related to traffic volume. The same is true for a hardware limited GW (e.g. GW X), if the bottleneck is more or less independent of the traffic volume, e.g. if the signaling processing capacity is the limiting resource. On the other hand, users would benefit from being allocated to other, less loaded GWs (e.g. GW Y), in order to avoid service degradation in the hardware limited case or potential service/bearer rejection in the license limited case. Although this is true for all users, the operator may choose to reserve this benefit for prioritized users.

Below follows a discussion of a number of criteria or different types of bearer associated information that, the MME 111, according to different embodiments, may use when determining in the step 24 which users to allocate to a loaded GW (e.g. GW X) and which to allocate or relocate to a less loaded GW (e.g. GW Y) and thus how to utilize the remaining capacity of the loaded GW (e.g. GW X) and/or to give selected subscribers the best possible service. Note that these criteria and the decision they are used for are applicable only to users, who, if the GW load was not considered, would be allocated to the currently loaded GW (e.g. GW X), i.e. the users for which this GW is considered the most favorable (appropriate) when the load is disregarded. Some types of information or criteria are applicable only to GWs with soft capacity limits, some are applicable only to GWs with hard capacity limits, and some are applicable to both.

Subscription Type:

Prioritized (e.g., gold) subscribers should be off-loaded earlier than subscribers with lower priority (e.g., bronze subscribers), so that the service is not degraded and/or bearer establishment rejections are avoided for prioritized subscribers. That is, in the soft limited case, when the level of service is starting to be significantly affected for users allocated to e.g. GW X, the MME 111 should start to selectively allocate the most precious subscribers to other GWs (e.g. GW Y) and as the load increases and service is more degraded, increasingly less “valuable” subscribers (e.g., silver subscribers) should be encompassed by the selective off-loading. In the hard limited case the selective off-loading should be applied when the load is getting close to the license limit. The subscription type may furthermore provide hints on the expected traffic volume. For instance, gold subscribers may be expected to generate higher traffic volumes than bronze subscribers (although this will of course not always be the case; bronze subscriber may for instance be heavy peer-to-peer users). Users with flat rate subscriptions may also be expected to generate more traffic than users with volume based charging. Similarly, high-quota subscribers may be expected to generate more traffic than low-quota subscribers. In hard limited cases the low volume users should be directed to less loaded GWs (e.g. GW Y instead of GW X) first since the traffic volume does not matter for the license limit and low volume users incur less increase of the transmission costs when directed via suboptimal paths. In soft limited cases the choice of whether to off-load high or low volume users depends on whether user or operator interests are prioritized. That is, for soft limited cases the user interest could be satisfied by off-loading either high volume users, which potentially suffer more from degraded service than low volume users, or several low volume users in case a certain amount of traffic is to be off-loaded, so that more users can avoid degraded service. The operator's interest would be to off-load as little traffic as acceptable, which typically means that low volume users should be off-loaded first, in order to avoid off-loading more traffic than necessary.

Selective off-loading of high or low volume users may also be used to balance the load in relation to a hard (assumedly license based) and a soft (assumedly hardware based) capacity limit in the same GW. A hard (e.g. license based) capacity limit is typically independent of the traffic volume, which means that the load in relation to the hard limit decreases equally much when a low volume user is off-loaded as when a high volume user is off-loaded. The soft (e.g. hardware based) capacity limit, on the other hand, is often dependent on the traffic volume, which means that off-loading a high volume user decreases the load in relation to the hard capacity limit more than off-loading a low volume user. Thus, selective off-loading strategies can be used to prevent that one of the capacity limits is reached when there is still a large margin to the other capacity limit and thereby ensure that the GW's resources are efficiently utilized. Similarly, selective off-loading may be used to regulate the loads relative the respective capacity limit of a hard (e.g. license) limited and a soft (e.g. hardware) limited GW, so that the resources of both GWs are more efficiently utilized.

Subscribed Services:

Information on services that the user of the bearer for which gateway allocation is to be performed may be used as input for GW selection according to the step 24. If the information on subscribed services indicate that the user may be expected to activate services requiring high bit rates, and maybe Guaranteed Bit Rate (GBR) bearers, which a soft limited loaded GW (e.g. GW X) is not likely to be able to support in its present state, it may be good to proactively allocate the user to another GW (e.g. GW Y) in the step 24.

The information on subscribed services may further or alternatively imply traffic volume expectations, in which case transmission optimal GWs (e.g. GW X) may be “reserved” for the higher data volumes. If the transmission optimal GW (e.g. GW X) is soft limited, this will however be a trade-off against the user's interest of receiving the best possible service. The traffic volume expectations may also be used for the purpose of balancing load in relation to hard and soft capacity limits, as described above.

If the user subscribes to services which require other bearers than the default bearer, which means that the user can be expected to want to establish more bearer(s), then, if the GW load is so close to its limit that there is a risk that the GW (e.g. GW X) will not be able to accommodate more bearers (i.e. typically a license limited GW), or if it can be expected to soon be in this state, then it may be good to proactively allocate the user to another GW (e.g. GW Y). The information on subscribed services, including implications of whether the user can be expected to establish more bearer(s), may also serve as input to balancing of load in relation to hard and soft capacity limits.

APN(s):

Information on the APN associated with the bearer for which GW allocation is to be performed may be used as input for GW selection according to the step 24. If the user associated with the bearer for which GW allocation is to be performed has not yet activated all the user's subscribed APNs, the user may be expected to want to establish another PDN connection and thus another bearer. Then, if the load is so close to the limit that there is a risk that the GW (e.g. GW X) will not be able to accommodate more bearers, or if it can be expected to soon be in this state, then it may be good to proactively allocate the user to another GW (e.g. GW Y). This applies mainly to SGW selection, since different PGWs may be chosen for different APNs, whereas the SGW will be the same for all PDN connections. However, if this governs the SGW selection, then it may indirectly govern also the PGW selection, if a combined SGW/PGW is desired. This APN information may also serve as input to balancing of load in relation to hard and soft capacity limits.

Possibly, a subscribed APN may additionally or alternatively provide hints about how much the expected traffic will suffer from degraded service, which may be used as input in the step 24 to select GW such that “sensitive” users are selectively off-loaded from the loaded GW.

Possibly, subscribed APN(s) may additionally or alternatively provide hints of the kind of traffic and volume of traffic that the user may be expected to generate, so that the operator can choose to selectively off-load either potential high or potential low volume users, depending on the nature of the capacity limit and on whether the operator or user benefits are prioritized as previously described. This type of APN-derived information on expected traffic may also be used for the purpose of balancing load in relation to hard and soft capacity limits, as described above.

Terminal Type/Terminal Capabilities:

Information on type of terminal, or the capabilities of the terminal that the bearer is to connect, may also serve as input for GW selection according to the step 24. For instance, a laptop modem may be expected to generate more traffic than a handset which enables the operator to selectively off-load either potential high or potential low volume users as previously described. This terminal information may thus also serve as input to balancing of load in relation to hard and soft capacity limits.

Current Bearer:

In case a GBR bearer is handed over during SGW relocation, the GBR setting implies which data rates that may be expected. This allows the operator to selectively off-load either high bit rate/high volume users or low bit rate/low volume users as previously described. This information about the already established bearer may also serve as input to balancing of load in relation to hard and soft capacity limits.

The number of currently established bearers is useful input data in bearer-based license limited cases of SGW relocation. This not only indicates how much the user will directly add to the bearer based load measure, but also gives a hint (albeit rather unreliable) about the probability that the user will later increase or decrease its number of bearers i.e. the larger the number of established bearers, the smaller the probability that the number of bearers will increase and the greater the probability that the number of bearers will decrease. To some extent this information derived from the number of currently established bearers may also be used as input to balancing of load in relation to hard and soft capacity limits.

Information on the quality of service associated with the currently established bearers may also be useful. The quality of service of a bearer may indicate the kind of traffic volumes that may be expected on the bearer and it may also provide information on the sensitivity, i.e. how much the carried traffic would suffer from the degraded performance of a soft limited GW. For instance, a bearer with guaranteed bit rate (GBR bearer) would assumedly be accepted by a GW only if the GW can guarantee to provide the required (guaranteed) data rate. Since the GW thus guarantees to maintain this data rate for this bearer, the traffic of this bearer will be spared service degradation even when the performance of a soft limited GW decreases, as the GW will ensure that the consequences of this performance degradation affects other (non-GBR) bearers (e.g. best-effort bearers). This information is thus useful for selective off-loading strategies in conjunction with both hard and soft limited GWs and it may also be used as input to balancing of load in relation to hard and soft capacity limits.

Information on the service or application whose traffic a bearer carries may imply what the reasonable expectations are on the traffic volume and the traffic characteristics (e.g. bit rate variations). As previously described, this type of information is thus potentially useful for basically all aspects of selective off-loading of GWs.

Per User Statistics:

Per user statistics may be used as input for GW allocation according to the step 24. Some statistics is at present available in GWs and it may be foreseen that further statistics might be available in GWs in the future. Such statistics may be transferred to the MME or SGSN e.g., using a private extension information element (IE) in GTPv2-C messages or future versions of the protocol. It is also conceivable that such statistics information could be made available to the MMEs through Operation and Maintenance (O&M) means. In general the per user statistics would provide indications of the probability of a certain user to generate low or high volumes of traffic, low or high bit rate traffic, traffic with low or high QoS requirement as well as its number of bearers. Potentially, the information may even allow an MME to estimate expected values of traffic volume, bit rate requirements, QoS parameters and/or number of bearers for a user. Per user statistics may indicate average traffic volumes per hour/day as well as usual peak rate requirements. Per user statistics may indicate how often/how large fraction of the time a user on average uses services with high service level requirements.

Per user statistics may also indicate how often/how large fraction of the time a user on average establishes multiple bearers and how many, which thus may indicate a probability of more bearers to be established for the user. Traffic statistics on the current session, regarding volume and/or rate per bearer and/or user, indicates the current “traffic state” of the user. Remaining traffic volume quota may provide hints of the traffic volume to expect. For instance, low remaining quota may suggest that lower traffic volumes are to be expected.

All the above mentioned types of statistics may be used in similar ways and for the same purposes as in the above descriptions in conjunction with the other selective off-loading criteria of how similar types of information can be used to enable/support selective off-loading.

GW allocation may be performed for a bearer that is to be established. However, in case of relocation of one or several already established bearers the GW allocation is carried out after establishment of the bearer(s). Thus in conjunction with a highly loaded SGW (e.g. GW X) the MME may decide to relocate already allocated users to other SGWs (e.g. GW Y) in order to obtain a more optimal distribution of users, taking the above criteria and potential desired benefits into account. Such relocation decisions may be made proactively, relocating a batch of subscribers in order to free capacity for coming subscribers which may be more optimal to allocate to the concerned SGW (e.g. GW X).

More likely, however, the relocation decisions would be made on a case by case basis, i.e. when a user is to be allocated to a GW (e.g. GW X), the MME may consider whether it would be beneficial to relocate another user in order to make the required capacity available for the new user.

Now an example of potential gain will be briefly discussed using a realistic example of how a selective GW allocation based on GW load can be used to achieve more efficient utilization of GW resources, in the control plane (CP) and user plane (UP), when used for balancing the load between license limited and hardware limited GWs.

### Assumptions:

One core site with two combined GW node types:
   License limited GW:
      Maximum number of bearers: 2.56*10⁶;
      Maximum throughput: 100 Gbps
Hardware limited GW:
   Maximum number of bearers: 6*10⁶;
   Maximum throughput: 10 Gbps.
Combined GW selection is favored.
The subscriber base may be divided in two main categories: 20%
   smartphone/laptop users: 45 kbps in busy hour; and 80% handheld device
   users: 1 kbps in busy hour.

### Achievable Loads:

Achievable loads with a standard GW selection algorithm according to 3GPP TS 29.303 are about 25% of the UP capacity when the license limit is reached in the license limited GW and 17% of the CP capacity when the hardware capacity limit is reached in the hardware limited GW.
Achievable loads with a GW allocation algorithm according to which handheld device users are directed to the hardware limited GW and smartphone/laptop users are directed to the license limited GW are about 87% of the CP capacity in the license limited GW and 60% of the UP capacity in the hardware limited GW, if selective off-loading of already allocated subscribers is not permitted, and about 100% on both GW types for both CP and UP, if selective off-loading of already allocated subscribers is permitted.

A fine-tuned selective GW allocation algorithm based on load related feedback could achieve higher loads, i.e. better capacity utilization than the above simple algorithm i.e. allocating handheld device users to hardware limited GWs and smartphone/laptop users to license limited GWs. The following is an example of a possible such algorithm.

Notation used in the algorithm:
S_{G} A set of available, selectable GWs.
g A GW belonging to the set S_{G} of GWs, i.e. gεS_{G}.
Lₗ(g) The load related to a license limit of the GW g i.e. typically a number of allocated and established bearers. In this example this load is assumed to be related to the CP load.
Lₕ(g) The load related to a hardware limit of the GW g i.e. typically carried traffic in bps. In this example this load is assumed to be related to the UP load.
Iₗ(u) The load incurred by a user, u, related to the license limit of a GW i.e. the typical number of bearers used by the user as implied by the user category.
lₕ(u) The load incurred by a user, u, related to the hardware limit of a GW i.e. the typical traffic bit rate in bps.
Cₗ(g) The license capacity limit of the GW g i.e. the maximum number of bearers this GW can handle).
Cₕ(g) The hardware capacity limit of the GW g i.e. the maximum throughput in bps that this GW can handle.

### Additional Assumption:

The mobility management control node knows the typical number of bearers per user for each user category, either from configuration or autonomously learnt through statistics.

Algorithm (to be used when a user, u, is to be allocated one of the GWs in S_{G}):

$$G = {arg min}_{g ∈ {S}_{G}} ( max ( \frac{{L}_{l} ( g ) + {l}_{l} ( u )}{{C}_{l} ( g )} , \frac{{L}_{h} ( g ) + {l}_{h} ( u )}{{C}_{h} ( g )} ) ) ;$$

### ALLOCATE USER u TO GW G;

Note: If argmin results in more than one GW, i.e. if load conditions are the same at several GWs, then the choice between these GWs is arbitrary for the allocation of user u.

The algorithm above is intended to select the GW in S_{G} that is least loaded in comparison to its capacity limits.

With the algorithm above maximum GW loads and thus resource utilization of ˜100% can be achieved on both license limited and hardware limited GWs for both UP and CP. However, note that this assumes a GW mix that covers the total CP and UP requirements during busy hour.

As mentioned above there are several different ways in which the mobility management control node may obtain GW load information in the step 22. A number of different alternatives will now be discussed in further detail below.

Two quantities are of particular interest when taking GW load information and potential selective off-loading of subscribers into account during GW allocation: the capacity limit of the GW and the current load of the GW. These two quantities are of particular interest with respect to the determined appropriate GW according to the step 21, but it is beneficial to also obtain knowledge of these two quantities with respect to each GW, which is feasible for GW allocation for a particular bearer or set of bearers, to facilitate selection of the most suitable GW in the step 24.

In addition to the two quantities mentioned above, the nature of the capacity limit, i.e. whether it is hard or soft, is also of interest. The capacity limit of a GW 105, 106 can be encoded into one of the FQDNs delivered to the MME 111 during the S-NAPTR procedure that is performed in conjunction with GW selection. Alternatively, it could be conveyed from the GW 105, 106 itself to the MME 111 in a GTPv2-C message (or future versions of the protocol). In the case of a PGW 106 the messaging would be relayed via the SGW 105. Another alternative is to configure the capacity limit of each GW 105, 106 in each MME 111 that may allocate UEs 101 to the GW 105, 106. Overload indications from a GW 105, 106 in the form of rejections of capacity allocation requests (e.g. Create Session Response messages with the Cause IE set to “No memory available” or “No resources available”) may also provide hints about the GW's 105, 106 capacity limit, at least if related to internal data in the MME 111, such as the number of bearers or UEs 101 the MME 111 has allocated to the GW. In all these alternatives an indication of whether the capacity limit is hard or soft may also be conveyed or configured together with the capacity limit or overload indication.

The current load of a GW 105, 106 could be explicitly indicated by the GW 105, 106 to the MME 111. If explicit indications are used for conveying of load information from a PGW 106, the indications would be relayed via the SGW 105.

An alternative to explicit load indications from GWs is that the MME 111 estimates the GW load based on MME internal data. These two alternatives of obtaining explicit GW load information or estimating the GW load information will be further elaborated upon in the following.

An advantageous means for conveying load information from the SGWs 105 and PGWs 106 to the MMEs 111 is the GTPv2-C protocol, which is used on the S11 interface between the MME 111 and the SGW 105 and on the S5 interface (and the S8 interface in a roaming scenario) between the SGW 105 and the PGW 106. Since extensions and/or future protocol upgrades are suggested herein, the protocol version may be, e.g. GTPv3-C or GTPv4-C, so in order to keep the notation sufficiently generic all these versions (i.e. version 2 and higher versions) will be referred to as GTPvN-C (where N≧2).

One embodiment would be to use the Private extension IE of GTPvN-C messages between the MME 111 and the SGW 105 for GW load communication. This could be done using any of the messages from the SGW 105 to the MME 111, such as e.g. the Create Session Response message. Alternatively, the information could be conveyed to the MME 111 in all GTPvN-C messages from the SGW 105 to the MME 111. An advantage of the latter is that it provides the MME 111 with as fresh GW load information as possible without introducing new messages in the signaling. The information transfer could also be done on request from the MME 111, in which case the MME 111 would indicate its request in the Private extension IE of a message to the SGW 105 and the SGW 105 would respond in the Private extension IE in the response message. Any GTPvN-C message exchange could be used for this request-response exchange.

It would also be possible to extend the GTPvN-C protocol (still potentially using the Private extension IE in various messages) to comprise a means for the MME 111 to order, or subscribe to, load information from a GW 105, 106. In such a case the load indications would be sent repeatedly from the GW 105, 106 to the MME 111. When subscribing to the load information the MME 111 could configure various parameters that govern when and how often the load information would be sent. For instance, the MME 111 could order whether the load information should be sent at specific predetermined times or sent opportunistically with the first message that is anyway to be sent after each predetermined time. The MME 111 could also configure the GW 105, 106 to send load indications only when the load has changed a certain minimum amount since the previous load indication was sent. There could also be a rate limit on the load indications such that e.g. no more than y load indications per second must be sent, where y may be load dependent, such that the load indication frequency increases (or is allowed to increase if motivated by large enough load changes) with increasing GW load. Yet another configuration option could be that the MME 111 instructs the GW 105, 106 to send load indications only when certain threshold values are passed. Some of these configuration options could be combined, whereas others are more or less alternatives to each other.

One aspect that complicates the methods utilizing GTPvN-C messages is that there is no interface between the MME 111 and the PGW 106, so the PGW 106 load information would have to be relayed by an SGW 105 to the MME 111. This may however be greatly simplified in a combined SGW/PGW node. An alternative to using the Private extension IE as above is to standardize new IE(s) and/or message(s) to support the feature. Possibly the feature could be introduced using the Private extension IE and if this use of the Private extension IE spreads, a dedicated IE may eventually be standardized.

According to another alternative embodiment the MMEs 111 use the management interfaces of the GWs 105, 106 for retrieving load information, e.g., using Simple Network Management Protocol (SNMP) for getting load information regularly from GWs 105, 106. An advantage of using the management interface instead of the GTPvN-C-based solution is that this method would work also in GWs without support for new, possibly Private extension IE based, GTPvN-C features.

However, management interface based information exchange between core network nodes may be difficult and complex to enable in real-world networks.

This difficulty could be overcome if a regular O&M system (not illustrated in FIG. 1) is used to collect the load information from the GWs 105, 106 and redistribute it to the MMEs 111. However, due to the slower time-scale the O&M system generally operates on, the load information would be available to the MME 111 with some delay, which would (possibly severely) reduce the efficiency of the method.

Yet other, alternative means for load information collection include using extensions of routing protocols between GWs 105, 106 and MMEs 111, e.g., opaque Open Shortest Path First (OSPF) Link State Advertisements (LSAs), or getting the load statistics indirectly through the charging system, e.g. by GWs reporting extended charging records to the charging system. Conveying GW load related information via DNS is also a possible method. Although a drawback is that undesirably frequent DNS updates may be required.

In all the above mentioned alternatives for conveying explicit GW load information to the MME 111, a possible option is to associate with the load information an indication of whether the load information relates to a hard or soft capacity limit, e.g. number of bearers (either in absolute terms or as a fraction of the GW's capacity) or processor load, and/or which type of capacity limit, a hard or a soft, that is currently the closest to being reached.

According to further alternative embodiments the load information conveyed from the GWs 105, 106 to the MME 111 may come in the shape of early overload warnings. That is, a GW 105, 106 proactively informs one or more

MME(s) 111 when the load in the GW 105, 106 is getting close to the GW's capacity limit, but before the GW actually reaches an overloaded state. Such a warning may be a trigger for an MME 111 to start using selective off-loading in the step 24 as described above.

A GW 105, 106 sending an early overload warning may also qualify the warning by a criticality factor, indicating how critical the warning is, e.g., how close the GW 105, 106 is to being overloaded and/or how critical the consequences would be of increasing the load or actually reaching an overload state. That is, the criticality factor may reflect both closeness to the capacity limit and the degree to which users/services would be affected by further increased GW load. Particularly the latter may be a property that is specific to each GW implementation and it would also differ greatly depending on whether the overload warning pertains to a soft or a hard capacity limit. Hence, inclusion of such a criticality factor together with the early overload warning would facilitate a generic implementation of selective off-loading for different GW models (i.e. different vendors, hardware configurations, etc.), as it would allow a reasonably consistent behavior based on the criticality factor.

An MME 111 may use the criticality factor to determine how aggressively to use the selective off-loading, e.g. what threshold to use when off-loading prioritized subscribers (e.g. gold and silver subscribers or only gold subscribers) or how much worse (e.g. longer or with lower data rate) user plane path that is acceptable for off-loaded subscribers.

The early overload warnings, as well as a possible associated criticality factor, could be included in GTPvN-C messages that are anyway to be sent to from GWs 105, 106 to MMEs 111 (i.e. “opportunistic” utilization of GTPvN-C messages), e.g., in the Private extension IE. However, if the GW 105, 106 should be able to control the exact point in time when to send a warning, a new GTPvN-C message pair has to be introduced for this purpose, unless the GW 105, 106 can use the Echo Request message for this purpose.

Like in the case of regular feedback of GW loads, a GW 105, 106 could have the option to include together with the early overload warning an indication of whether the overload warning relates to a hard or soft capacity limit and/or which type of capacity limit, a hard or a soft, that is currently the closest to being reached.

As an alternative to communication of explicit GW load information in the step 22, the mobility management control node may estimate the GW load. In general, an MME 111 may estimate the load of different GWs 105, 106 based on internal data, i.e. the number of bearers or UEs 101 the MME 111 has allocated to the GWs 105, 106. However, in the general and typical case, there will be several MMEs 111 allocating bearers/UEs to the same GWs 105, 106. Hence, in order for an MME's 111 GW load estimates to be reasonably accurate, the MME 111 has to have a notion of how much load other MMEs may have allocated to the GWs 105, 106.

A prerequisite for this condition to be fulfilled is that all MMEs 111 that can allocate bearers/UEs to the concerned GWs 105, 106 can be considered equal in terms of geographical service area, the total set of GWs they may allocate bearers/UEs to, and the load distribution and GW selection algorithms they use. That is, the MMEs allocations to a given set of GWs should use the same “allocation profile”. If these conditions are met and the number of bearers/UEs allocated to the GWs is large enough to smoothen out statistical fluctuations, the MME 111 should be able to scale up its own allocations to a reasonably good estimate of the actual number of bearers/UEs allocated to a certain GW 105, 106, which in turn represents a fair measure of the load of the GW 105, 106.

For SGWs 105, the MMEs 111 which can allocate bearers/UEs depend on the mapping between SGW service areas and MME pool areas. All MMEs which control (have S1 interfaces to) eNBs 102 which belong to a certain SGW's 105 service area may allocate bearers/UEs to the SGW, provided that the concerned UE 101 is connected to an eNB 102 which fulfills this condition. Hence, in practice this means that in order for the above condition about equal allocation profile to be fulfilled, SGW service areas and MME pool areas should map one-to-one or many-to-one. No SGW service area should span across an MME pool area border. A special case is where only a single SGW service area and a single MME pool area are used, both covering the entire PLMN. PGWs 106 are not divided into service areas, since all PGWs serve the entire PLMN. Therefore all MMEs 111 in the PLMN may allocate bearers/UEs to all PGWs 106. Hence, the only certain way to fulfill the equal allocation profile condition for PGW 106 selection is to let all MMEs 111 belong to a single MME pool whose area covers the entire PLMN.

The following paragraphs describe a few different embodiments of estimating GW loads based on MME internal records of the bearers or UEs that the MME 111 has allocated to different GWs 105, 106.

When the above criteria are fulfilled, an MME 111 may estimate the loads of the GWs 105, 106 by maintaining internal counters of the bearers and/or UEs it allocates to different GWs. This information will anyway be stored in the MME 111 in the form of context data for the UEs 101 that are registered in the MME 111. To estimate the number of bearers or UEs allocated to a GW 105, 106 the MME 111 multiplies the counter value for this GW by the number of MMEs that allocate bearers/UEs to this GW.

If different MMEs have different selection probabilities in the MME selection algorithms of the eNBs 102, e.g. because the MMEs have different capacities, then the MME 111 would ideally know these selection probabilities for the different MMEs and adjust the GW load estimations accordingly. To be precise, the MME 111 needs to know its own share of the bearers/UEs that are allocated by the group of MMEs (e.g. the MMEs in an MME pool) and this is reflected by the MME's own selection probability in the eNBs' MME selection algorithm. The sum of the MMEs' selection probabilities is 1, so if the selection probability of MME j is pⱼ, then the number of bearers, bₖ, or UEs allocated to GW k is estimated by dividing the MME's bearer counter for GW k, c_{k,j}, by pⱼ, i.e. bₖ=c_{k,j}/pⱼ. To emphasize that the calculated number of bearers/UEs allocated to a GW is an estimation by the MME and that estimates may differ slightly between different MMEs, the bₖ parameter may be complemented with an index indicating the MME that performed the estimation, i.e. b_{k,j}=/pⱼ for the estimate of the number of bearers/UEs allocated to GW k calculated by MME j. Yet a possible option, which resolves all uncertainties of the other MMEs' allocations to different GWs, is that the MMEs, e.g. the MMEs in an MME pool, synchronize, i.e. shares, their respective bearer/UE allocation counter values with each other.

A slightly different way of estimating the GW loads, which neither relies on knowledge of the number of allocating MMEs nor the MME's own selection probability will now be described. Actually, the MME 111 does not even have to have explicit measures of the GWs' capacities. Instead of estimating a GW's absolute load, the MME rather estimates the GW's load in relation to its capacity limit. The only externally provided information that the MME needs is a parameter indicating the fraction f of full load a GW is dimensioned to have during busy hour according to the operator's network engineering policies. GW specific fractions, fₖ for GW k, could preferably be configured in DNS resource records which e.g. would be conveyed to the MME during the S-NAPTR procedure associated with GW selection. Fraction parameters, whether they are GW specific or not, could also be configured in the MME 111.

Let c_{k,j} denote the number of bearers/UEs currently allocated to GW k by MME j and let N_{k,j} denote the average number of bearers/UEs that MME j has allocated to GW k during busy hour. N_{k,j} is dynamically learnt and adjusted by measuring the parameter during repeated busy hour periods. MME j can now assume, as an approximate estimate, that the capacity limit of GW k is reached when MME j has allocated c_{k,j}=N_{k,j}/fₖ=M_{k,j} bearers/UEs to GW k. Consequently MME j can estimate the load of GW k in relation to its capacity limit, Iₖ as Iₖ=c_{k,j}/M_{k,j}=c_{k,j} fₖ/N_{k,j}.

A similar, but slightly different relative load estimation method utilizes statistical weight parameters associated with GWs. The weight parameters, wₖ for GW k, are preferably received from DNS in the shape of Preference parameters in NAPTR RRs or Weight parameters in SRV RRs, but they could also be encoded in GW FQDNs, configured in the MME via O&M or even conveyed from the GWs themselves in new GTPvN-C messages and/or new IEs or the Private extension IE in existing GTPvN-C messages. A weight parameter Wₖ is proportional to the capacity of GW k normalized by the sum of w parameters of all the GWs that MME j allocates UEs to. That is, with g denoting the number of GWs the MME allocates bearers/UEs to, then for an average GW w=1/g, for a GW with greater than average capacity w>1/g and for a GW with less than average capacity w<1/g). Furthermore N_{k,j} is replaced by N_{J}, denoting the average total number of bearers/UEs for which MME j has simultaneously allocated a GW, i.e. including the MME's all allocated bearers/UEs and all GWs the MME allocates to, during busy hour. With these parameters MME j can estimate that the capacity limit of GW k is reached when MME j has allocated c_{k,j}=Nⱼ wₖ/fₖ=M_{k,j} bearers/U Es to GW k. Consequently MME j can estimate the load of GW k in relation to its capacity limit as Iₖ=c_{k,j}/M_{k,j}=c_{k,j}fₖ/Nⱼwₖ.

Yet another alternative approach is to leverage overload indications from GWs, i.e. allocation rejection messages, e.g. in response to Create Session Request messages, with the Cause IE set to “No memory available” or “No resources available”, in combination with the above described principle for relative GW load estimation. The idea is to determine the MME internal bearer/UE counter values corresponding to the GW load limitations based on the overload indications received from a given GW. If the counter value of a certain GW is tracked at overload indications, e.g., through exponential averaging, the MME may view this learnt counter value as a rough estimate of the capacity limit of the GW, i.e. this way MME j can estimate M_{k,j} for GW k. Consequently MME j can estimate the load of GW k in relation to its capacity limit as Iₖ=c_{k,j}/M_{k,j} where M_{k,j} is the counter value learnt based on the overload indications from GW k.

As a possible refinement an MME may distinguish between the allocated bearers based on their associated QoS, such that, e.g., dedicated bearers with high guaranteed bit rate (GBR) are given greater weight, e.g., in terms of “bearer equivalents”. With this refinement both a GW's total capacity and its currently allocated load would be expressed in terms of bearer equivalents instead of bearers. The “bearer equivalent” abstraction could be useful even for default best effort bearers, because the MME could assume different traffic volumes on different default bearers based on subscription data or terminal type. This refinement would be particularly useful in a soft limited GW where the user plane hardware is the capacity bottleneck.

If the MME uses number of allocated users/UEs as proxy for load, then this may be refined by using a similar abstraction called “user/UE equivalent” to account for different user behavior resulting in different GW load, e.g., based on subscriber data or terminal type.

According to a further alternative embodiment a combination of explicit load information and open loop load estimation is used. With this combined approach the MME 111 could rather infrequently receive explicit information about GW loads and use open loop load estimation in the periods in between. That is, when the explicit load information is received, the MME 111 adjusts its perception of the GW load, compensating for any possible deviation between the open loop estimate and the explicit load information. Then the MME relies on the open loop estimates again until it receives explicit load information the next time.

The explicit load information could be retrieved from the GW via SNMP, either directly from the MME or via the O&M system, or through any of the methods for regular feedback of GW loads described above. As for the open loop load estimation part, any of the methods described above for GW load estimation could be used.

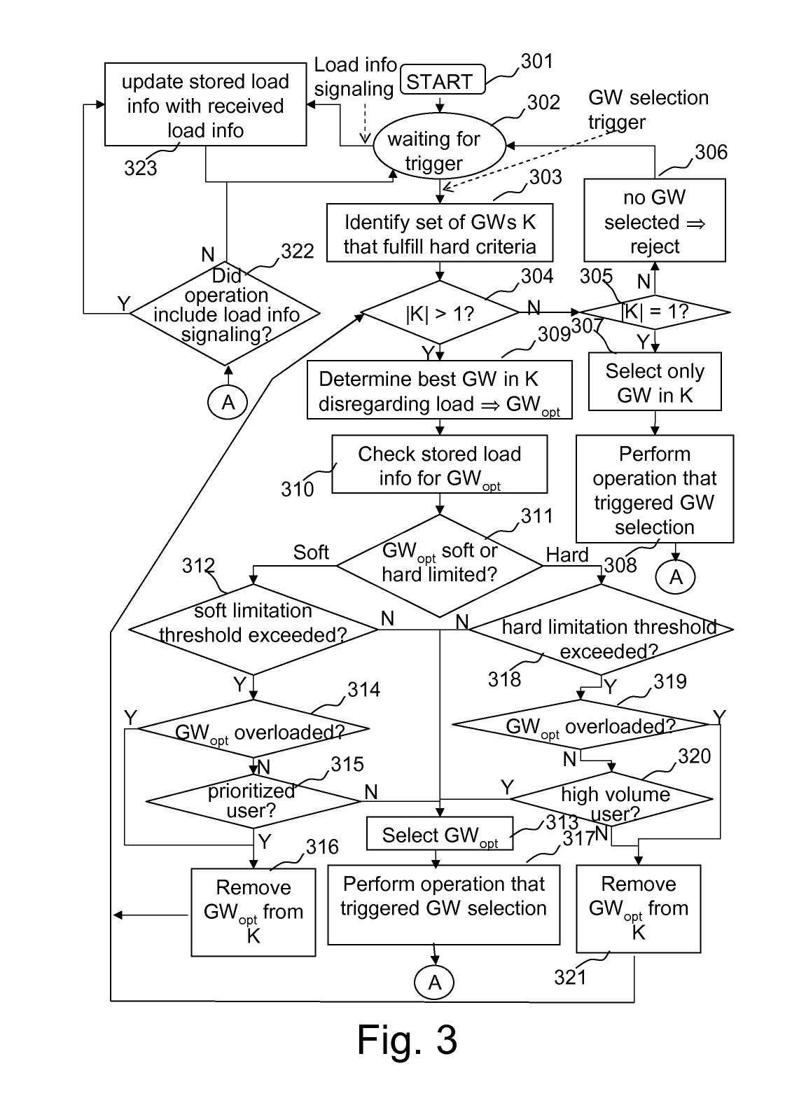

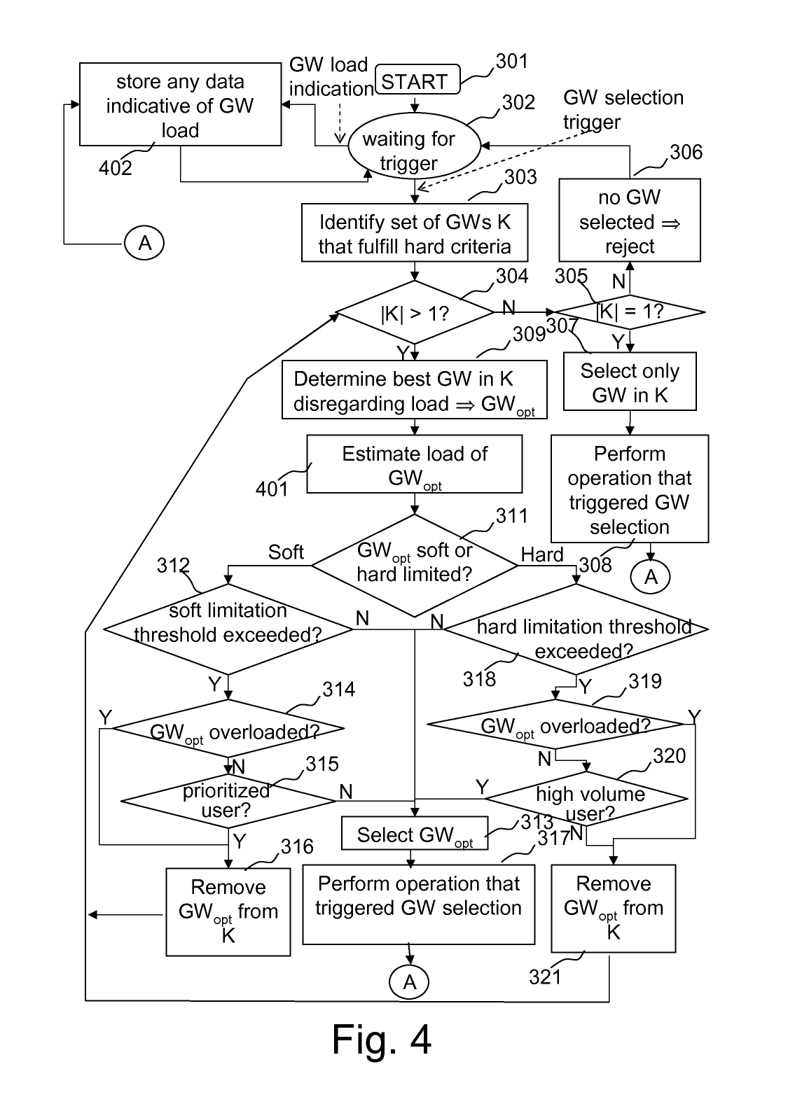

With the different strategies and different options for obtaining load information described above, different alternative embodiments of a method for GW allocation can be pieced together. Two alternative exemplary embodiments of a method in a mobility management control node for gateway allocation are illustrated by the flow charts in FIG. 3 and FIG. 4. In FIG. 3 explicit GW load information is used as input, while in FIG. 4 an estimated gateway load is used as input for GW selection. In both flow charts, although not explicitly mentioned, the MME is aware of whether the concerned GW is hard or soft limited, either from configuration or via information from the GW, and can thus treat the two cases separately.

The method in FIG. 3 starts at step 301. In a step 302 the mobility management control node is waiting for a trigger for GW selection or updating of GW load information. If a trigger for GW selection is received, such as a request for establishment of a bearer, a step 303 is performed. In the step 303 a set K of feasible GWs is identified, i.e. GWs that fulfill criteria that a GW must fulfill in order to be allocated to the bearer, so-called hard criteria. In a step 304 it is checked whether there is more than one GW in K that can be allocated to the bearer. If there is not more than one GW in K, it is examined in a step 305 if there is exactly one GW in K. If the step 305 indicates that there is no feasible GW, no GW is selected and the bearer establishment is rejected in a step 306. If the step 305 indicates that there is exactly one GW in K, then the only GW in K is selected in a step 307. In a step 308 the operation that triggered the GW selection is performed, such as the bearer establishment. If the step 304 indicates that there is more than one GW in K, the best (appropriate) GW, GWₒₚₜ in K disregarding GW load is determined in a step 309. GWₒₚₜ is in this embodiment the transmission optimal gateway. There are different conventional methods for determining the transmission optimal gateway. In a step 310, stored load information for the GWₒₚₜ is checked. It is determined if the GWₒₚₜ is soft or hard limited in a step 311. Depending on whether the GWₒₚₜ is soft or hard limited it is determined in step 312 or 318 respectively if a soft limitation threshold or a hard limitation threshold has been exceeded. The soft limitation threshold and the hard limitation threshold has been chosen to indicate a load level when it is considered appropriate to carefully select how the GWs remaining capacity is used. Note that the soft limitation threshold and hard limitation threshold may differ between different GWs. If the soft limitation threshold or hard limitation threshold is not exceeded, GWₒₚₜ is selected in a step 313 and the operation that triggered the GW selection is performed, such as the bearer establishment, in a step 317. If the soft limitation threshold or the hard limitation threshold is exceeded according to steps 312 and 318 respectively, it is examined in steps 314 and 319 respectively if GWₒₚₜ is overloaded. If GWₒₚₜ is overloaded, GWₒₚₜ is removed from K in steps 316 and 321 respectively and the procedure returns to the step 304. If GWₒₚₜ is not overloaded and GWₒₚₜ is soft limited, it is examined if the user, which is associated with the bearer, is a prioritized user in a step 315. If the user is a prioritized user, the step 316 is performed to selectively off-load the user from GWₒₚₜ and the user is thus spared the risk of experiencing service degradation due to GWₒₚₜ approaching an overload state. However, if the user is not a prioritized user the step 313 followed by the step 317 are performed, such that GWₒₚₜ is selected. If GWₒₚₜ is not overloaded and GWₒₚₜ is hard limited, it is examined if the user, which is associated with the bearer, is a high volume user or can be expected to be a high volume user in a step 320. If the user is not a high volume user and is not expected to be a high volume user, the step 321 is performed to selectively off-load the user from GWₒₚₜ so that the remaining capacity in GWₒₚₜ can be saved for high volume users. Accordingly, if the step 320 indicates that the user is a high volume user, the step 313 followed by the step 317 are performed, such that GWₒₚₜ is selected. After the step 308 and 317, a step 322 may be performed in which it is checked if the operation that triggered the GW selection include GW load information signaling, in other words if performing the operation results in any new updated information regarding any GW loads. If the step 322 is answered in the affirmative, the stored GW load information is updated in a step 323, otherwise the procedure returns the step 302. The step 323 may also be performed if signaling including GW load information is received at any other occasion not connected to a triggered GW selection.

The method illustrated by FIG. 4 is similar to the method illustrated by FIG. 3. In FIG. 4, the same reference numerals as in FIG. 3 are used for steps that correspond to steps in FIG. 3. Therefore only those method steps that differ from FIG. 3 will be described in detail.

According to the method illustrated in FIG. 4, the GW load information is obtained in a step 401 by estimating the load of GWₒₚₜ instead of performing the step 310 described above in connection with FIG. 3. The step 401 may be performed according to any of the different ways of estimating a GW load that have been discussed above. After performing the step 308 or the step 317, or if any indication of a GW load is received at another time, a step 402 may be performed. In the step 402 data indicative of a GW load may be stored. This data may then be used for performing the step 401 of estimating the load of GWₒₚₜ.

Although several of the embodiments and examples described above assume an implementation in an EPS network architecture, it is to be understood that embodiments of the invention also are applicable to 3G/UMTS networks. In 3G/UMTS the SGSN has the role of the MME and the GGSN has the role of the PGW. The SGSN and the GGSN can communicate directly, i.e. without relay, using GTP-C. Although the GTP-C version of 3G/UMTS might be upgraded to newer versions in the future, this may or may not become the same version as is used in EPS networks. Hence, when the embodiments described herein are applied to selective off-loading of GGSNs in 3G/UMTS, the protocol that could be used carry load information from the GGSN to the SGSN would probably be another version of GTPvN-C (or GTP-C) than in an implementation in EPS.

In 3G/UMTS the SGSN also has the role of the SGW, i.e. it is a combined mobility control node and user plane node. SGSNs can communicate with each other using GTP-C and hence explicit SGW load information may be conveyed in a similar way as SGW load information in EPS, although probably using another protocol version. However, since the mobility control part of an SGSN is always combined with a user plane part, retrieval of the load information for the integrated user plane part is trivial.

There is no DNS method for GGSN selection specified in the standard for 3G/UMTS, corresponding to the DNS method for PGW selection in EPS. However, DNS may still be used for GGSN selection in product implementations, so the above described DNS features, e.g. conveying weight parameters, may still be used in proprietary solutions.

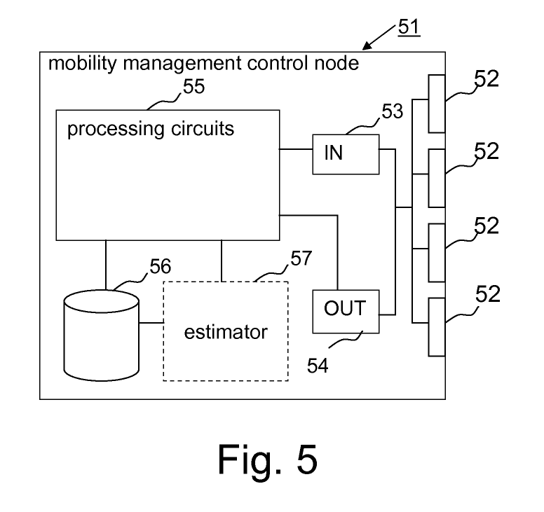

FIG. 5 is a schematic block diagram illustrating an embodiment of a mobility management control node 51. The mobility management control node 51 comprises a number of ports or interfaces 52 over which messages may be exchanged with other connected network nodes. An input unit 53 is provided to support reception of messages over the ports/interfaces 52 and an output unit 54 is provided to support sending of messages over the ports/interfaces 52. The mobility management control node 51 further comprises processing circuits 55. The processing circuits 55 may comprise hardware, software, firmware or combinations thereof that are adapted to perform the method steps described in FIG. 2, 3 or 4. The processing circuits would generally include software modules. These software modules may be part of one or several computer program products embodied in the form of a volatile or non-volatile memory, e.g. a random access memory (RAM), an EEPROM, a flash memory or a disc drive. The computer product(s) may comprise software modules for performing the method steps of FIG. 2, 3 or 4. A memory 56 may be provided in the mobility management control node 51 for storing data such as information indicative of GW loads. Furthermore, the mobility management control node may optionally comprise an estimator 57 adapted to estimate a GW load according to the step 401 or any of the procedures for GW load estimation described above.

From the above description it may be understood that an advantage of some embodiments present herein is that it is made possible to implement smart selective off-load strategies to be applied in the context of load management of GWs, such as SGWs and PGWs, or SGSNs and GGSNs. It is possible to retrieve accurate and timely load information and base load management decisions on this load information prior to a GW actually becoming overloaded. Thus it is possible to get an indication that resources are to be managed carefully prior to a situation where an overloaded GW rejects requests for allocation of further resources. According to current standards the previous possibilities are not provided.

Another advantage is that some embodiments enable an operator to choose how to best utilize the last capacity of a highly loaded GW. This results in more efficient resource utilization and, if the operator so desires, lower transmission costs.

Another advantage is that some embodiments enable an operator to balance the load in relation to license and hardware limits, e.g. CP and UP capacity limits, thereby achieving more efficient resource utilization.

A further advantage of certain embodiments is that an operator is enabled to ensure that prioritized subscribers are spared the inconvenience, in the form of service degradation and/or bearer rejection, of being connected to a highly loaded GW.

Yet a further advantage of certain embodiments is that different selective off-load/load management strategies can be applied to soft and hard limited GWs, i.e. to GWs limited by soft capacity limit or a hard capacity limit respectively.

Another advantage is that embodiments may be partly standardized or entirely proprietary.

In the drawings and specification, there have been disclosed typical preferred embodiments of the invention and, although specific terms are employed, they are used in a generic and descriptive sense only and not for purposes of limitation, the scope of the invention being set forth in the following claims.

### LIST OF ABBREVIATIONS USED HEREIN

3G 3rd Generation
3GPP 3rd Generation Partnership Project
A RR A DNS resource record for resolving a FQDN into an IPv4 address.
AAAA RR A DNS resource record for resolving a FQDN into an IPv6 address
APN Access Point Name
AS Autonomous System
ASBR Autonomous System Border Router
bps Bits per second
CP control plane
DDDS Dynamic Delegation Discovery System
DNS Domain Name System
EDGE Enhanced Data rates for GSM Evolution
eNB eNodeB
EPS Evolved Packet System
E-UTRAN Evolved UTRAN
FQDN Fully Qualified Domain Name
GBR Guaranteed Bit Rate
GERAN GSM EDGE Radio Access Network
GGSN Gateway GPRS Support Node
GPRS General Packet Radio Service
GSM Global System for Mobile communication
GTP GPRS Tunneling Protocol
GTP-C The control plane part of GTP.
GTPv2-C The control plane part of GTP version 2.
GTPv3-C The control plane part of GTP version 3 (a yet non-existing version).
GTPv4-C The control plane part of GTP version 4 (a yet non-existing version).
GTPvN-C The control plane part of GTP version 2 and higher versions (where W2).
GW Gateway
GW X A GW which is transmission optimal (i.e. the best GW from a user plane path optimization perspective), but with a load that is approaching the GW's capacity limit.
GW Y A GW which is worse than GW X from a transmission (user plane path optimization) perspective, but which is less loaded than GW X.
HSS Home Subscriber Server
ID Identity
IE Information Element
IMS IP Multimedia Subsystem
IP Internet Protocol
IPv4 Internet Protocol version 4
IPv6 Internet Protocol version 6
LSA Link State Advertisement
MCC Mobile Country Code
MME Mobility Management Entity
MNC Mobile Network Code
NAPTR Name Authority Pointer (A DNS resource record type.)
O&M Operation and Maintenance
OSPF Open Shortest Path First
PCRF Policy and Charging Rules Function
PDN Packet Data Network
PGW PDN Gateway
PLMN Public Land Mobile Network
PSS Packet-switched Streaming Service
QoS Quality of Service
RR Resource Record
S1 The interface between an eNB and the EPS core network
S11 The interface between an MME and a SGW
S1-MME The control plane part of the S1 interface (between an eNB and an MME).
S1-U The user plane part of the S interface (between an eNB and a SGW)
S5 The interface between a SGW and a PGW
SA Service Area
SeGW Security Gateway
SGSN Serving GPRS Support Node
SGW Serving Gateway
S-NAPTR Straightforward NAPTR
SNMP Simple Network Management Protocol
SRV The DNS Service resource record type.
TAO Tracking Area Code
TAI Tracking Area Identity
TAU Tracking Area Update
TS Technical Specification
UE User Equipment
UMTS Universal Mobile Telecommunications System
UP user plane
UTRAN Universal Terrestrial Radio Access Network

1-24. (canceled)

25. A method in a mobility management control node of a mobile communications system for allocating a gateway to at least one bearer of traffic, the method comprising:
determining an appropriate gateway for the at least one bearer;
obtaining load information indicating a current load of the determined appropriate gateway;
if the obtained load information indicates that the current load of the determined appropriate gateway is above a predetermined threshold value of the determined appropriate gateway,
selecting a gateway out of the determined appropriate gateway and at least one other gateway based on information associated with the at least one bearer;
if the obtained load information indicates that the current load of the determined appropriate gateway is below or at the predetermined threshold value,
selecting the determined appropriate gateway; and
allocating the selected gateway to the at least one bearer.

26. The method according to claim 25, wherein the predetermined threshold value is a soft limitation threshold, which is a threshold value relative to a traffic volume capacity limit of the determined appropriate gateway.

27. The method according to claim 26, wherein, if the load information indicates that the current load of the determined appropriate gateway is above the soft limitation threshold and the information associated with the at least one bearer indicates that the user associated with the at least one bearer is a prioritized user, selecting one of the at least one other gateway.

28. The method according to claim 25, wherein the predetermined threshold value is a hard limitation threshold, which is a threshold value relative to a capacity limit of the determined appropriate gateway, which capacity limit limits the number of bearers, the number of users or the number of user equipments handled by the determined appropriate gateway.

29. The method according to claim 28, wherein, if the load information indicates that the current load of the determined appropriate gateway is above the hard limitation threshold,
selecting the determined appropriate gateway if the information associated with the at least one bearer indicates an expected traffic volume at or above a predetermined volume level, and
selecting one of the at least one other gateway if the information associated with the at least one bearer indicates an expected traffic volume below the predetermined volume level.

30. The method according to claim 25, wherein the information associated with the at least one bearer is one or several of the following types of information:
information on subscription type associated with a user associated with the at least one bearer,
information on services that the user associated with the at least one bearer subscribes to,
information on Access Point Names that the user associated with the at least one bearer subscribes to,
information on the Access Point Name associated with the at least one bearer,
information on type of terminal that the at least one bearer is to connect,
information on capabilities of the terminal that the at least one bearer is to connect,
information on the quality of service associated with the at least one bearer,
information on at least one service or application whose traffic the at least one bearer is or will be carrying,
information indicating a current or expected traffic volume of the at least one bearer, and
information on per user statistics associated with the user associated with the at least one bearer.

31. The method according to claim 25, wherein the load information includes explicit load information, which originates from the determined appropriate gateway and which is received in the mobility management control node.

32. The method according to claim 25, wherein the load information includes an estimate, based on data available in the mobility management control node, of the current load of the determined appropriate gateway.

33. The method according to claim 25, wherein when selecting a gateway out of the determined appropriate gateway and at least one other gateway based on information associated with the at least one bearer, also basing the selection of the gateway on information indicating a respective current load of the at least one other gateway.

34. The method according to claim 25, wherein the mobility management control node is a Mobility Management Entity of an Evolved Packet System or a Serving GPRS Support Node.

35. The method according to claim 25, wherein allocating the selected gateway to the at least one bearer occurs prior to establishment of the at least one bearer.

36. The method according to claim 25, wherein the at least one bearer is at least one already established bearer for which gateway relocation is to be preformed.

37. A mobility management control node for use in a mobile communications system, the mobility management control node comprising processing circuits configured to allocate a gateway to at least one bearer of traffic, wherein the processing circuits are configured to:
determine an appropriate gateway for the at least one bearer;
obtain load information indicating a current load of the determined appropriate gateway;
if the obtained load information indicates that the current load of the determined appropriate gateway is above a predetermined threshold value of the determined appropriate gateway,
select a gateway out of the determined appropriate gateway and at least one other gateway based on information associated with the at least one bearer;
if the obtained load information indicates that the current load of the determined appropriate gateway is below or at the predetermined threshold value,
select the determined appropriate gateway; and
locate the selected gateway to the at least one bearer.

38. The mobility management control node according to claim 37, wherein the predetermined threshold value is a soft limitation threshold, which is a threshold value relative to a traffic volume capacity limit of the determined appropriate gateway.

39. The mobility management control node according to claim 38, wherein the processing circuits are adapted to select one of the at least one other gateway if the load information indicates that the current load of the determined appropriate gateway is above the soft limitation threshold and the information associated with the at least one bearer indicates that the user associated with the at least one bearer is a prioritized user.

40. The mobility management control node according to claim 37, wherein the predetermined threshold value is a hard limitation threshold, which is a threshold value relative to a capacity limit of the determined appropriate gateway, which capacity limit limits the number of bearers, the number of users or the number of user equipments handled by the determined appropriate gateway.

41. The mobility management control node according to claim 40, wherein the processing circuits are adapted to, if the load information indicates that the current load of the determined appropriate gateway is above the hard limitation threshold,
select the determined appropriate gateway if the information associated with the at least one bearer indicates an expected traffic volume at or above a predetermined volume level, and
select one of the at least one other gateway if the information associated with the at least one bearer indicates an expected traffic volume below the predetermined volume level.

42. The mobility management control node according to claim 37, wherein the information associated with the at least one bearer is one or several of the following types of information:
information on subscription type associated with a user associated with the at least one bearer,
information on services that the user associated with the at least one bearer subscribes to,
information on Access Point Names that the user associated with the at least one bearer subscribes to,
information on the Access Point Name associated with the at least one bearer,
information on type of terminal that the at least one bearer is to connect,
information on capabilities of the terminal that the at least one bearer is to connect,
information on the quality of service associated with the at least one bearer,
information on at least one service or application whose traffic the at least one bearer is or will be carrying,
information indicating a current or expected traffic volume of the at least one bearer, and
information on per user statistics associated with the user associated with the at least one bearer.

43. The mobility management control node according to claim 37, wherein the load information includes explicit load information, which originates from the determined appropriate gateway and wherein the mobility management control node comprises a receiver configured to receive the explicit load information.

44. The mobility management control node according to claim 37, wherein the load information includes an estimate of the current load of the determined appropriate gateway and wherein the mobility management control node comprises an estimator for estimating the current load of the determined appropriate gateway based on data available in the mobility management control node.

45. The mobility management control node according to claim 37, wherein the processing circuits are configured to, when selecting a gateway out of the determined appropriate gateway and at least one other gateway based on information associated with the at least one bearer, also base the selection of the gateway on information indicating a respective current load of the at least one other gateway.

46. The mobility management control node according to claim 37, wherein the mobility management control node is a Mobility Management Entity of an Evolved Packet System or a Serving GPRS Support Node.

47. The mobility management control node according to claim 37, wherein the processing circuits are configured to allocate the selected gateway to the at least one bearer prior to establishment of the at least one bearer.

48. The mobility management control node according to claim 37, wherein the at least one bearer is at least one already established bearer and wherein the processing circuits are configured to perform gateway relocation for the at least one bearer.
